(19) United States
(12) Patent Application Publication
(10) Pub. No.: US 2004/0163578 A1
(43) Pub. Date: Aug. 26, 2004

(54) Seed eductor assembly

(76) Inventors: Roger C. McDonald, Dodge City, KS (US); Thomas A. Klenke, Spearville, KS (US); Donald F. Hornung, Dodge City, KS (US)

Correspondence Address: Wm Bruce Day, Swanson Midgley LLC, Suite 400, 2420 Pershing Road, Kansas City, MO, 64108, US

(21) Appl. No.: 10/371,854

(22) Filed: Feb. 21, 2003

(51) Int. Cl. A01C 7/00; A01C 9/00

(52) U.S. Cl. 111/175

(57) ABSTRACT

An eductor assembly is adapted for seed delivery and is designed to reduce or eliminate clogs. The eductor uses a compartment comprising a feed section into which falls seed from a primary storage hopper. A primary pneumatic tube runs through the compartment and continues on to delivery sites such as secondary hoppers which feed the seed to singulators. A secondary pneumatic tube branches from the primary tube and opens into the compartment generally below the primary tube, pressurizing the compartment and creating turbulence sufficient to prevent seed from packing. An eductor tube is mounted within the compartment and has an open, lower end that extends from adjacent the termination of the secondary pneumatic tube so that seed accumulating in the compartment is drawn through the eductor. The eductor tube at its upper end extends into the primary pneumatic tube and has an outlet end positioned so as to form a constriction in the first pneumatic line to create a venturi to draw seed through the eductor tube. Any clogs that occur at the constriction in the primary pneumatic tube are relieved by a concurrent increase in air pressure and flow rate through the secondary pneumatic tube to urge seed through the eductor and break the clog. Additionally, the turbulent mixing of the seed in the eductor compartment inhibits packing, bridging and clogging of the seed.

### FIELD OF THE INVENTION

This invention relates to pneumatic conveyors, and particularly to such conveyers which are adapted for delivery of seed, grain or other particulate matter.

### BACKGROUND OF THE INVENTION

Agricultural seeders have commonly used pneumatic conveying apparatus to deliver seed from a primary seed hopper or bin through delivery tubes to secondary seed hopers mounted on seed planting implements, planters for corn, soybeans and other large seeds. From the secondary hoppers, seed is dropped into simple seed delivery devices, generally termed singulators, and usually consisting of a pocket wheel. Blower fans to provide air duct pressure are powered from the hydraulic pump of the towing tractor sufficient to create a low pressure ducting system. With the low pressure, and high weight to surface area ratio of the seed to be conveyed, such as corn, soybean or milo seed, problems with clogging have occurred. Typically, the seeds are distributed through a gravity feed or venturi feed system, and the clogging can occur at constriction points, even including the venturi throat. The present invention is intended to provide an eductor apparatus which is specifically designed for conveyance of seed grain and in which the susceptibility to pack and clog is substantially reduced or eliminated.

### OVERVIEW OF THE INVENTION

The present invention is an eductor assembly which is adapted for seed delivery and is designed to reduce or eliminate clogs throughout the delivery ducting. The eductor uses a compartment comprising a feed section into which falls grain from a primary storage hopper. A primary pneumatic tube runs through the compartment and continues to delivery sites, such as openers or planter seed tubes. A secondary pneumatic tube runs from a second pressurized air source, or as shown in the illustrated example, branches from the primary pneumatic tube upstream of the compartment and opens into the compartment generally below where the primary tube enters the compartment. The secondary pneumatic tube pressurizes the compartment. An inductor tube is mounted within the compartment and has an open, lower end that extends from adjacent determination of a secondary pneumatic tube so the seed accumulating in the compartment is blown into the eductor. The eductor tube at its upper end extends into the primary pneumatic tube and has an outlet end positioned so as to form a constriction in the first pneumatic tube to create an venturi which draws seed from the compartment and through the eductor tube. Any clogs that occur at the constriction are quickly relieved by a concurrent increase in air pressure and flow rate through the secondary pneumatic tube to urge seed through the eductor and break the clog.

### OBJECTS OF THE INVENTION

The objects of the present invention are: to provide an inductor system for pneumatic delivery of particulate matter; to provide such an inductor system which is particularly adapted for delivery of seeds; to provide such an inductor system which reduces any tendency to clog and stop flow; and to provide such an inductor system which is simple, readily manufactured, and well intended for the purpose. Other objects and advantages of this invention will become apparent from the following description, which provides an exemplary embodiment of the invention.

### DESCRIPTION OF THE DRAWINGS

FIG. 1 is a perspective view of a grain eductor assembly embodying the present invention.

FIG. 2 is a longitudinal sectional view of the grain eductor assembly.

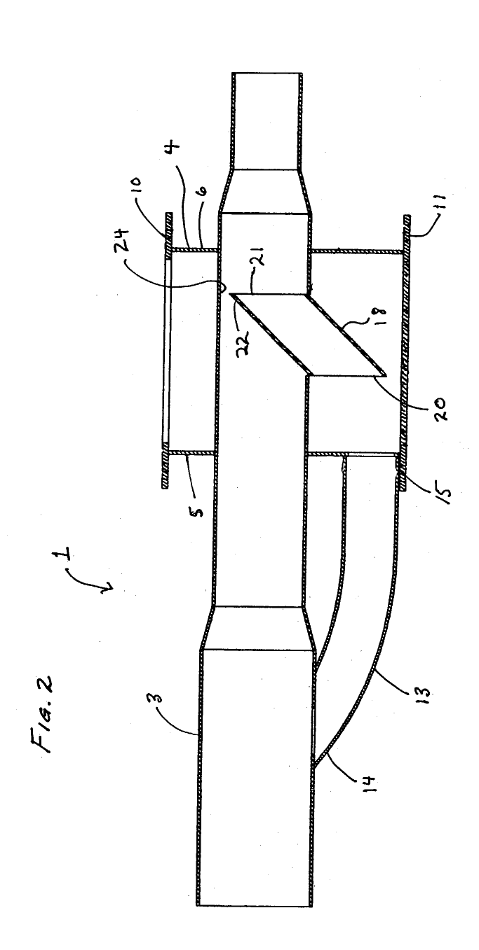

FIG. 3 is a longitudinal sectional view of the grain eductor assembly showing a grain-receiving compartment filled with grain.

FIG. 4 is a longitudinal sectional view of the grain eductor assembly showing a beginning step of air-flow through the eductor.

FIG. 5 is a longitudinal sectional view of the grain eductor assembly showing operational air delivery of grain.

### DESCRIPTION OF THE PREFERRED AND OPTIONAL EMBODIMENTS

As required by the statutes and case law, a detailed embodiment of the present invention is disclosed herein. It is, however, to be understood that the disclosed embodiment is merely exemplary of the invention, which may be embodied in various forms. Therefore, specific structural and functional details disclosed herein, are not to be interpreted as limiting, but merely as a basis for the claims and as a representative basis for teaching one skilled in the art to variously employ the present invention in virtually any appropriately detailed structure.

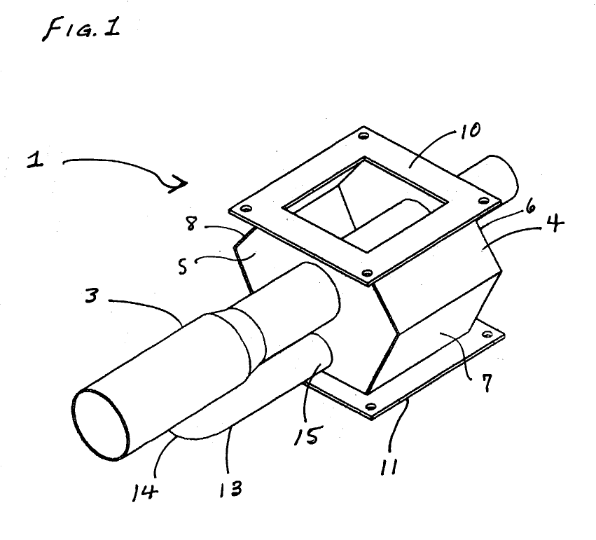

The reference 1, FIG. 1, generally indicates a grain eductor assembly embodying the present invention. The eductor assembly 1 is positioned in the line of a primary air delivery tube 3 and mounted generally under a primary seed grain storage hopper (not shown). The seed eductor assembly 1 is generally used for delivery of particulate matter from a source thereof, such as a seed storage bin or hopper, and a delivery site (not shown) downstream of the primary air delivery tube or duct 3. A typical installation is for a seed drill or planter implement wherein a prime mover, such as an agricultural tractor, first pulls a wheel-mounted primary seed hopper with seed from the hopper transferred to a drill or planter implement which is towed behind the seed hopper. Pneumatic ducting, including the primary air delivery tube 3, extends from the primary seed hopper to secondary seed hoppers mounted on the drill or planter. Seeds then fall from the secondary seed hopper into a singulator device, typically a pocket wheel, then down seed tubes into an earth opening created by an opener tool. This system pneumatic assembly is powered by a blower (not shown) which acts as a source of pressurized air. The blower motor is powered by the hydraulic pump of the tractor. The seed eductor assembly 1 is generally positioned below the seed hopper and is at least in gravity communication with the primary seed hopper so that seed grain falls from the hopper into a container 4 with upstream and downstream end walls 5 and 6, and opposite side walls 7 and 8. A top peripheral flange 10 connects to other structural components such as the bottom of the seed hopper. A bottom plate 11 closes the container 4. The side walls 7 and 8 are angled outwardly to increase capacity.

The primary air delivery tube or duct 3 extends through the container 4 generally at mid level. In the illustrated example, FIG. 1, the upstream portion of the duct 3 includes a step-down, or reduction, in diameter so as to maintain volumetric carrying capacity. A secondary air tube or duct 13 branches from the primary air duct 3 at its first end 14 upstream of the container 4 and has a second end 15 terminating and opening through the upstream end wall 5. In the illustrated example, the secondary delivery tube or duct 13 branches from the primary air delivery tube 3; however, it is conceivable that the secondary air delivery tube 13 could use a secondary source of pressurized air and need not branch from the primary. Additionally, as shown in the drawing figures, the secondary air tube second end 15 extends into the container 4 at a location immediately below the primary air delivery tube 3. However, it is foreseen that the secondary air tube might join the container 4 at a different location laterally of the through extension of the primary tube.

An eductor tube 18 is mounted within the container 4, and in the illustrated example, consists of a short length of tubing or duct with spaced 45 degree ends. The first 45 degree end 20 opens into the container 4 adjacent the bottom plate 11, or bottom of the container, and in close proximity to the outlet of the secondary air tube 13 so as to receive air delivery from the secondary air tube 13. The second end 21 of the eductor tube 18 extends upwardly into the primary delivery tube 3 and has an upper portion 22 forming a constricted throat or venturi 24. As the eductor tube 18 is essentially a tube within the tube of the primary air tube 3, the venturi 24 is created not only at the point of the upper portion 22 but to a lessor extent around the periphery of the eductor tube second end 21. Air flow passing through the primary air delivery tube 3 and through the venturi 24 creates a pressure drop sufficient to create suction through the eductor tube 18 to carry particulate matter or seed grain from the container 4 into the primary air delivery tube 3, and thereon to delivery sites.

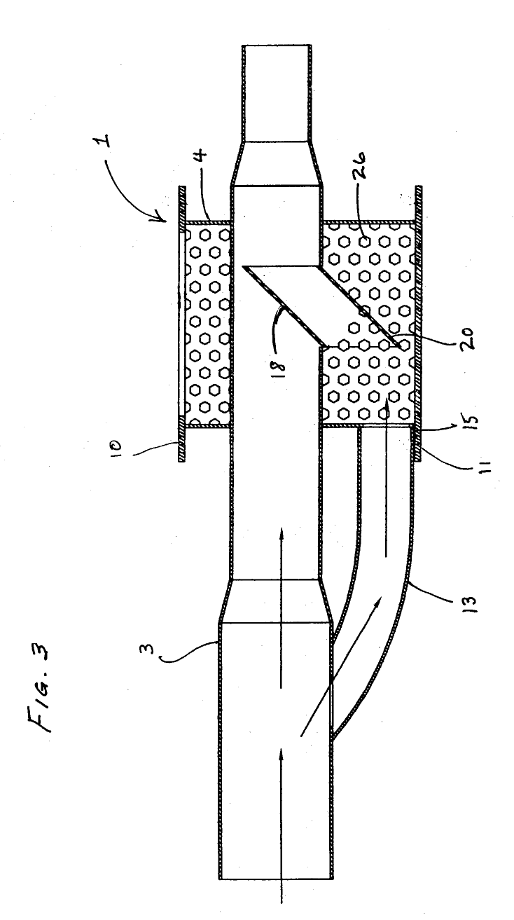

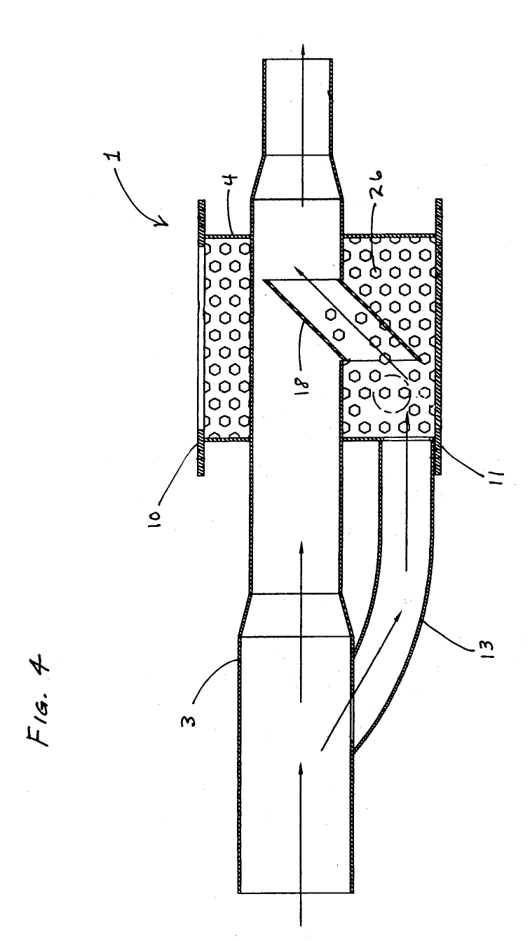

A sequence of operation is shown in FIGS. 3-5. The beginning sequence is shown in FIG. 3, wherein particulate matter such as seed 26 has filled container 4 from top to bottom, as by gravity feed from an overlying seed hopper (not shown). Pressurized air travels through the primary duct 3 and accelerates as it passes the constriction formed by the eductor tube 18, creating a low pressure zone immediately downstream of the juncture of the eductor tube 18 with the primary air delivery tube 3. Concurrently, air is drawn off through the branch of the secondary air delivery tube 13 to pressurize the packed seed in the immediate area between the outlet or second end 15 of the secondary air tube 13 and the first end opening 20 of the eductor tube 18. The pressurized air blowing into that area creates a turbulent mixing of the seed which, when combined with the low pressure zone created in the eductor 18, draws the seed upwardly through the eductor tube 18. FIG. 4 shows the turbulent mixing indicated by the air-flow arrows and the start of seed movement upwardly through the eductor tube 18.

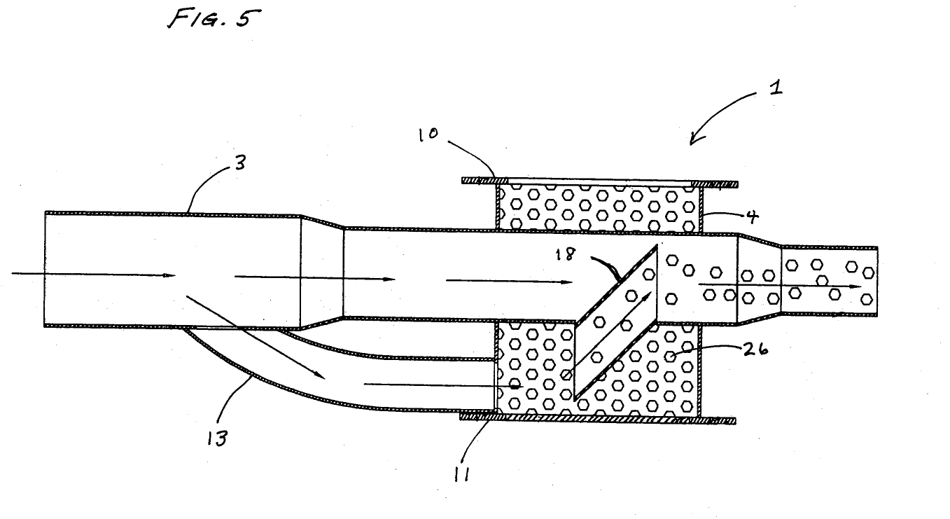

FIG. 5 shows continuous seed delivery operation of the eductor 1. Therein, pressurized air travels both through the primary air delivery tube 3 and the secondary air delivery tube 13, low pressure is created at the constriction of the eductor 18, and pressurized air is blown into that portion of the container 4 which is between the end opening 15 of the secondary air delivery tube 13 and the open end 20 of the eductor 18. The combination of turbulent mixing and blowing air from the secondary air delivery tube 13 and suction created in the eductor tube 18 has been found to significantly reduce clogs and promote smooth flow of seed through the primary air delivery tube 3. While the greatest tendency to clog is at the entrance to the eductor 18 in the container 4, which is alleviated by the blowing and mixing air from the secondary air delivery tube 13, there can be an additional possibility of clogging at the outlet of the eductor tube 18 in the air delivery tube 3. These clogs additionally are broken or alleviated by the dual route of air through the primary air delivery tube 3 and the secondary air delivery tube 13. Concurrently with any clog appearing in either the primary air delivery tube 3 or the secondary air delivery tube 13, there is increased pressure in the other tube which has been found sufficient to break any clumps and clogs thus far seen to be forming. This is particularly important because seed can tend to pack tightly in delivery system components because of the vibration of the implement as it travels over a rough field surface. The turbulent stirring of the seed in the compartment 4 tends to alleviate packing or bridging tendencies and to promote flow. Additionally, field tests have shown that packing of seed in the delivery line from the primary hopper to secondary hoppers is much reduced with the present invention. A typical installation would use a primary hopper gravity flowing seed into a plurality of eductor assemblies mounted thereunder, each eductor assembly in turn transferring seed via a dedicated air delivery tube to a single secondary seed hopper, then through a singulator such as a pocket wheel to a gravity drop tube depositing the seed in a ground opening made by an opener tool. With the use of the present invention, when each secondary seed becomes full and stops air flow into that hopper, the primary delivery tube remains fairly clear and does not tend to clog. This is believed to be because there must be sufficient air flow rate to pull the seed upwardly through the eductor tube and then through the primary delivery tube. When air pressure begins to reduce, due to the secondary hoppers approaching full, seed flow rate up the eductor quickly reduces, yet air flow remains sufficient to convey seed in the delivery tube to the secondary hopper. When air flow begins again, due to seed flowing out of the secondary hopper, the little seed remaining in the air delivery tube is quickly transferred, and full draw resumes quickly through the eductor.

Having described the above preferred embodiment, it will become apparent that various modifications can be made without departing from the scope of the invention as defined in the accompanying claims.

What is defined and desired to be secured by Letters Patent is:

1. A clog reducing eductor assembly for delivery of particulate material, comprising:
a. a particulate material feed section for receiving particulate material from a supply thereof;
b. a primary air delivery tube extending through the feed section and continuing to delivery sites;
c. a secondary air tube branching from said primary air delivery tube from an upstream location and opening into said feed section;
d. an eductor tube having a first end opening into said feed section for receiving particulate material and a second end extending into the primary air delivery tube so as to form a constriction therein to create a venturi to draw particulate material from the feed section through the eductor tube for conveying through said primary air delivery tube, the air from said secondary air tube exerting pressure upon particulate material in said feed section to urge it into said eductor tube, with any clogs occurring at the constriction in said primary air delivery tube being relieved by a concurrent increase in air pressure and air flow through said secondary air tube.

2. In a planter assembly comprising a seed box, a carrier, and a plurality of seed delivery tools, the seed being pneumatically transported from the seed box to the delivery tools, the improvement comprising a clog reducing eductor assembly comprising:
a. a seed feed section generally positioned below the seed box and receiving seed therefrom;
b. a first pneumatic line extending through the seed feed section and ending adjacent the delivery tools;
c. a second pneumatic line connected to the feed section and terminating therein;
d. an eductor tube mounted within the feed section and having an inlet adjacent the termination of the second pneumatic line so as to blow seed accumulating in the feed section between the termination of the second pneumatic line and the inlet of the eductor tube, into the eductor tube, and the eductor tube extending into the first pneumatic line and having an outlet end positioned so as to form a constriction in the first pneumatic line to create a venturi to draw seed through the eductor tube, any clogs occurring at the constriction in said primary pneumatic line being relieved by a concurrent increase in air pressure and air flow rate through said second pneumatic line to urge seed through the eductor tube.

3. The eductor assembly set forth in claim 2 wherein the second pneumatic line branches from the first pneumatic line from a location upstream of the seed feed section.

4. The eductor assembly set forth in claim 2 wherein the feed section is positioned below the seed box and seed gravity falls into the feed section.
